(19) United States
(12) Patent Application Publication
(10) Pub. No.: US 2009/0116857 A1
(43) Pub. Date: May 7, 2009

(54) IMAGE FORMING APPARATUS

(75) Inventors: Yu Tanaka, Tokyo (JP); Hiroyuki Wakabayashi, Tokyo (JP); Masaaki Uchiyama, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo, (JP)

(21) Appl. No.: 12/132,975

(22) Filed: Jun. 4, 2008

(30) Foreign Application Priority Data
Nov. 7, 2007 (JP) JP2007-289713

(51) Int. Cl. G03G 15/00

(52) U.S. Cl. 399/23

(57) ABSTRACT

Disclosed is an image forming apparatus including: an image forming section for forming an image on a sheet; a tray on which an image-formed sheet is discharged as a discharged-sheet; and a controller for setting an amount of sheet to be discharged, the amount being smaller than a load limit of discharged-sheet on the tray, obtaining an amount of the sheet on the tray, comparing the obtained amount of the sheet with the set amount of the sheet, and executing at least one of warning about the amount of the discharged-sheet and stopping an image forming job for driving the image forming section on the basis of the comparison result.

### BACKGROUND OF THE INVENTION

The entire disclosure of Japanese Patent Application No. 2007-289713 filed on Nov. 7, 2007 including description, claims, drawings, and abstract are incorporated herein by reference in its entirety.

1. Field of the Invention

The present invention relates to an image forming apparatus.

2. Description of Related Art

A copying machine that is equipped with an elevating type tray in which a large amount of discharged sheets can be loaded, and can discharge a large amount of sheets has been hitherto known as a copying machine for printing image data or copying an original document.

In the copying machine that can discharge a large amount of discharged sheets, the loading capacity of sheets in the tray is limited. When sheets are continued to be discharged with no cease until the limitation thereof, a loading failure may occur due to a curl problem of the sheet discharge or the like. Therefore, there is known a copying machine, which is equipped with a pause button for temporarily stopping a sheet discharging and temporarily stops a job in accordance with an input of the pause button. Furthermore, there is also proposed a copying machine in which a pause timing is set from among immediately, at a break of jobs, or at a break of sets, etc. in accordance with the length of time for which the pause button is pressed during execution of a job, thereby temporarily stop sheet discharging (for example, see JP-A-2004-196429).

However, in the construction of the above conventional copying machine, a temporary stop of a job is set by an user's operation after the job is started. Therefore, when a user is not at the job place or the user does not perceive the status of an amount of discharged sheet, the job is executed until the load limit of the tray and thus there is a risk that a loading failure in discharging sheets on the tray may occur.

### SUMMARY OF THE INVENTION

In accordance with an aspect of the present invention, there is provided an image forming apparatus including: an image forming section for forming an image on a sheet; a tray on which an image-formed sheet is discharged as a discharged-sheet; and a controller for setting an amount of sheet to be discharged, the amount being smaller than a load limit of discharged-sheet on the tray, obtaining an amount of the sheet on the tray, comparing the obtained amount of the sheet with the set amount of the sheet, and executing at least one of warning about the amount of the discharged-sheet and stopping an image forming job for driving the image forming section on the basis of the comparison result.

Moreover, in accordance with another aspect of the present invention, there is provided an image forming apparatus including: an image forming section for forming an image on a sheet; a tray on which an image-formed sheet is discharged as a discharged-sheet; an informing section for informing a warning; and a controller for setting a first amount of the discharged-sheet at which a warning about the amount of the discharged-sheet should be performed before a load limit of the tray, obtaining an amount of the discharged-sheet on the tray, comparing the obtained amount of the discharged-sheet with the first amount of the discharged-sheet, and making the informing section inform the warning about the amount of the discharged-sheet when the obtained amount of the discharged-sheet reaches the first amount of the discharged-sheet.

Preferably, the image forming apparatus further includes a first operating section for accepting an input about a second amount of the discharged-sheet on the tray to be taken out before the load limit, wherein the controller sets the second amount of the discharged-sheet input from the first operating section, starts an image forming job to make the image forming section form an image, obtains an amount of the discharged-sheet on the tray, compares the obtained amount of the discharged-sheet with the second amount of the discharged-sheet, and stops the job when the obtained amount of the discharged-sheet exceeds the second amount of the discharged-sheet.

Preferably, the image forming apparatus further includes a second operating section for accepting an input about the first amount of the discharged-sheet, wherein the controller sets the first amount of the discharged-sheet input from the second operating section.

Preferably, the controller calculates and sets the first amount of the discharged-sheet corresponding to the second amount of the discharged-sheet input from the first operating section.

Preferably, the image forming apparatus further includes a weight measuring section for measuring the weight of discharged-sheet on the tray as an amount of the discharged-sheet, wherein the controller compares the amount of the discharged-sheet obtained through the measurement by the weight measuring section with the set first amount of the discharged-sheet.

Preferably, the image forming apparatus further includes a discharged-sheet detecting section for detecting discharged-sheet on the tray, wherein during the stop of the job, the controller resumes the suspended job when no discharged-sheet on the tray is detected by the discharged-sheet detecting section.

Preferably, the controller stops the job at the break of a set including the set second amount of the discharged-sheet or at the break of a set which does not exceed the second amount of the discharged-sheet.

Preferably, the controller changes an informing method of the informing section when the obtained amount of the discharged-sheet reaches the second amount of the discharged-sheet.

Preferably, the image forming apparatus further includes a third operating section for accepting an input of an instruction for stopping the job, wherein the controller stops the job when an instruction of stopping the job is input from the third operating section after a warning of the amount of the discharged-sheet is informed.

Preferably, the image forming apparatus further includes a fourth operating section for accepting an input of an instruction for resuming the job, wherein during stop of the job, the controller resumes the suspended job when an instruction of resuming the job is input from the fourth operating section.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a diagram showing an image forming apparatus according to a first embodiment of the present invention.

FIG. 2 is a block diagram showing the internal construction of the image forming apparatus.

FIG. 3 is a flowchart showing first processing for warning about discharged sheets.

FIG. 4A is a diagram showing an input screen for inputting the number of sheet to be taken out.

FIG. 4B is a diagram showing an input screen for inputting the number of sheet for warning occurrence.

FIG. 4C is a diagram showing a warning screen.

FIG. 5 is a flowchart of a modification of the first processing for warning about discharged sheets.

FIG. 6 is a flowchart showing second processing for warning about discharged sheets.

FIG. 7 is a flowchart showing third processing for warning about discharged sheets.

FIG. 8 is a diagram showing an input screen for inputting a weight of sheets to be taken off.

### DESCRIPTION OF THE PREFERRED EMBODIMENTS

### First Embodiment

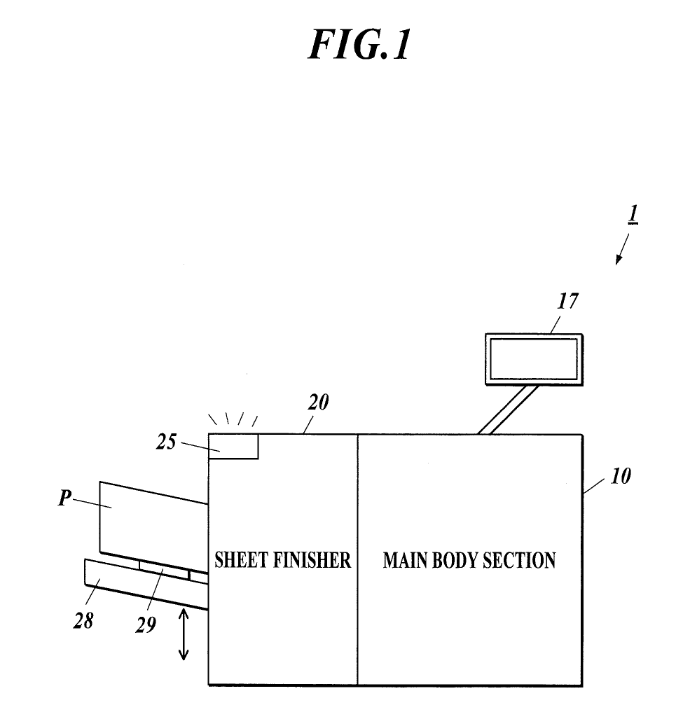

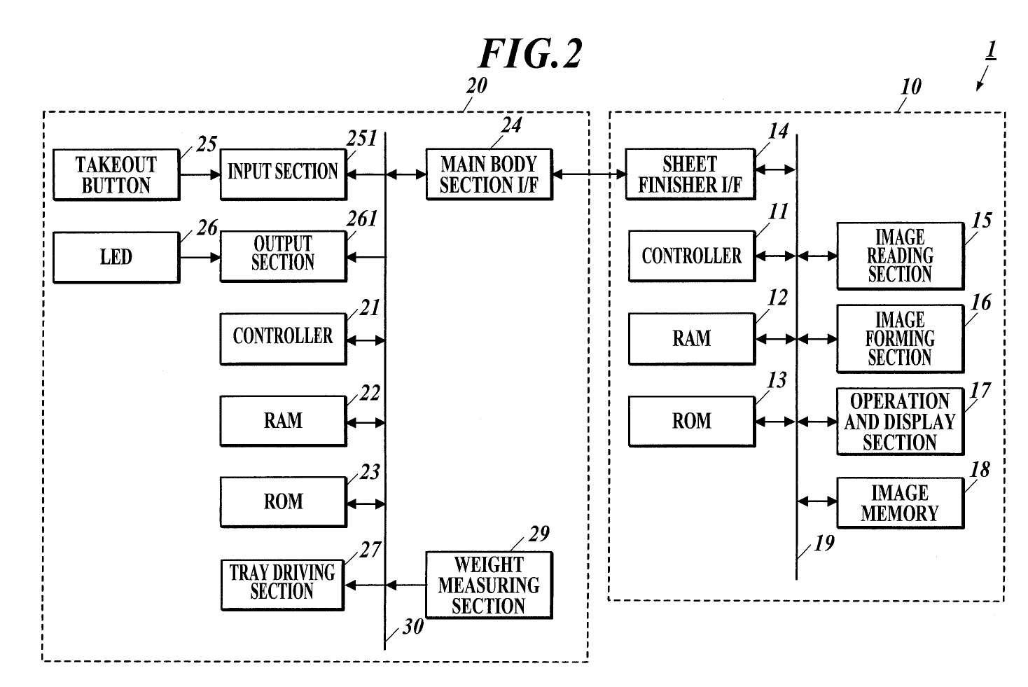

A first embodiment according to the present invention will be described with reference to FIGS. 1 to 4C. First, the construction of the apparatus of this embodiment will be described with reference to FIGS. 1 and 2. FIG. 1 shows an image forming apparatus 1 according to this embodiment. FIG. 2 shows an internal construction of the image forming apparatus 1.

In this embodiment, a copying machine is used as the image forming apparatus 1. However, other image forming apparatuses such as a printer, etc. may be used as the image forming apparatus. The image forming apparatus 1 is a monochromatic image forming apparatus, however, it may be a color image forming apparatus. Here, the sheet contains not only paper, but also OHP (Over Head Projector) sheet, etc.

As shown in FIG. 1, the image forming apparatus 1 has a main body section 10 and a sheet finisher 20. The main body section 10 has an operation and display section 17, etc. The main body section 10 has an image reading function to read an original document to generate image data, an image forming function to form (print) an image of the image data on a sheet, a displaying function to display various kinds of things on the operation and display section 17, and an operational function to accept an operation input from a user through the operation and display section 17.

The sheet finisher 20 has a take-out button 25, a tray 28 on which a sheet is discharged, and a weight measuring section 29, etc. The sheet finisher 20 has a function of discharging a sheet having an image formed thereon by the main body section 10 as a discharged sheet P to the tray 28, a tray elevating function to move the tray 28 vertically in accordance with the number of discharged sheets (an amount of discharged sheet) of the discharged sheets P, and a weight measuring function to measure the weight of discharged sheets on the tray 28 by the weight measuring section 29.

The internal construction of the image forming apparatus 1 will be described with reference to FIG. 2. The main body section 10 of the image forming apparatus 1 comprises a controller 11, RAM (Random Access Memory) 12, ROM (Read Only Memory) 13, a sheet finisher I/F (interface) 14, an image reading section 15, an image forming section 16, an operation and display section 17 as a first operating section, a second operating section and an informing section, and an image memory 18. These sections are connected to one another through a bus 19.

The sheet finisher 20 of the image forming apparatus 1 comprises a controller 21, RAM 22, ROM 23, a main body section I/F 24, a takeout button 25 as a third operating section, a fourth operating section and an informing section, an input section 251, LED (Light Emitting Diode) 26 as an informing section, an output section 261, a tray driving section 27, and a weight measuring section 29. The controller 21, RAM 22, ROM 23, the main body section I/F 24, the input section 251, LED 26, the tray driving section 27 and the weight measuring section 29 are connected to each other through a bus 30.

The controller 11 of the main body section 10 comprises CPU (Central Processing Section), and centrally controls the respective sections of the image forming apparatus 1. By the controller 11, an indicated program is read out from a system program and an application program, each program being stored in ROM 13, and the indicated program is expanded into RAM 12. Various kinds of processing are executed in cooperation of the expanded program and the controller 11.

The controller 11 sets a number of sheets to be taken out and a number of sheets for warning occurrence, each number being input through the operation and display section 17 on the basis of the first sheet discharge warning program read out from ROM 13, and starts an image forming job. When the number of discharged sheets reaches the number of sheets for warning occurrence, a warning message is displayed on the operation and display section 17, and turns on and off LED 26 of the takeout button 25. Furthermore, the controller 11 temporarily stops the job at the break of the set containing the number of sheets to be taken out in response to the press of the takeout button 25, and resumes the image formation in response to the re-press of the takeout button 25.

The maximum number of discharged sheets P which can be loaded on the tray 28 is defined as the load limit (a limited number of sheet being able to be loaded). The number of sheet to be taken out is a number of sheets smaller than the load limit of the discharged sheets P on the tray 28, and it is a frequency number of the discharged sheets P to be taken out. The number of sheet for warning occurrence is a number smaller than the number of sheet to be taken out, and it is a number at which a warning occurs to prepare for taking out the discharged sheets P although the discharged sheets P are not collapsed.

RAM 12 is a volatile memory for temporarily storing information, and has a work area for storing various kinds of programs and various kinds of data. ROM 13 is a memory for readably store information. A first sheet discharge warning program is stored in ROM 13. The sheet finisher I/F 14 is communicably connected to the main body section I/F 24, and transmits/receives information to/from the sheet finisher 20.

The image reading section 15 has a photoelectric converter (not shown), etc. The image reading section 15 optically reads an original document mounted on an original document mount table (not shown) according to a control signal from the controller 11 to photoelectrically convert the original document to an electrical signal, obtains image data (image signal) from the electrical signal and then outputs the image data to the controller 11.

The image forming section 16 has a color or monochromatic electrophotographic type image forming unit (not shown) and a fixing unit (not shown). The image forming section 16 forms an image on a sheet fed from a sheet supply tray (not shown) by the electrophotographic system according to a control signal from the controller 11, and discharges the image-formed sheet to the sheet finisher 20. The image forming section 16 is the electrophotographic type image forming section. However, it is not limited to this, and it may be other types of image forming sections such as an ink jet type, a thermal transfer type, a dot impact type, etc.

The operation and display section 17 has a display section such as LCD (Liquid Crystal Display) or the like, and an operating section. The operating section is constructed by a touch panel integrally with the display section. The operation and display section 17 displays various kinds of display information on the display section according to the control signal from the controller 11. Furthermore, the operation and display section 17 accepts a touch operation from a user to obtain the operation information and transmits the operation information to the controller 11. The operating section may have various kinds of keys, and it may be constructed so as to accept an operation input based on press of various kinds of keys or constructed in combination with a key system, a touch panel system or the like.

The image memory 18 stores the image data generated in the image reading section 15.

The controller 21 of the sheet finisher 20 comprises CPU, and centrally controls the respective sections of the sheet finisher 20. An indicated program is read out from the various kinds of programs stored in ROM 23 and expanded into RAM 22 by the controller 21, and various kinds of processing are executed in cooperation of the expanded program and the controller 21. The controller 21 executes various kinds of control of the sheet finisher 20 according to the control signal from the controller 11.

The controller 21 controls to feed the image-formed sheet discharged from the main body section 10 through a feeding passage (not shown) and discharge the image-formed sheet to the tray 28. At this time, the controller 21 controls the tray 28 in accordance with the amount of sheets discharged (the number of discharged sheets) to the tray 28 through a tray driving section 27 so that the tray 28 is elevated to a height suitable for discharging sheet, and discharges sheets.

RAM 22 is the same as RAM 12 and ROM 23 is the same as ROM 13. ROM 23 stores a program for the sheet finisher 20. The main body section I/F 24 is communicably connected to the sheet finisher I/F 14, and transmits/receives information with the main body section 10.

The takeout button 25 accepts a press input from the user when the discharged sheets P are taken out from the tray, and outputs it as a press signal. The input section 251 outputs the press signal input from the takeout button 25 to the controller 21. The output section 261 generates a driving signal on the basis of the control signal for LED 26 input from the controller 21, and outputs the driving signal to LED 26. LED 26 is provided in the takeout button 25, and it is turned on, turned on and off and turned off in accordance with the driving signal input from the output section 261.

The tray driving section 27 drives the tray 28 and elevates the tray 28 in accordance with the control signal for LED 26 input from the controller 21. The weight measuring section 29 has a weight sensor, and the weight measuring section 29 is mounted on the tray 28. The weight measuring section 29 measures the weight of the sheets P on the tray 28 by the weight sensor, and outputs a weight signal representing the weight thereof to the controller 21.

The image forming apparatus 1 may be communicably connected to an external equipment such as PC (personal Computer) or the like, receive image data from the external equipment, and form an image on a sheet by the image forming section 16 on the basis of the image data.

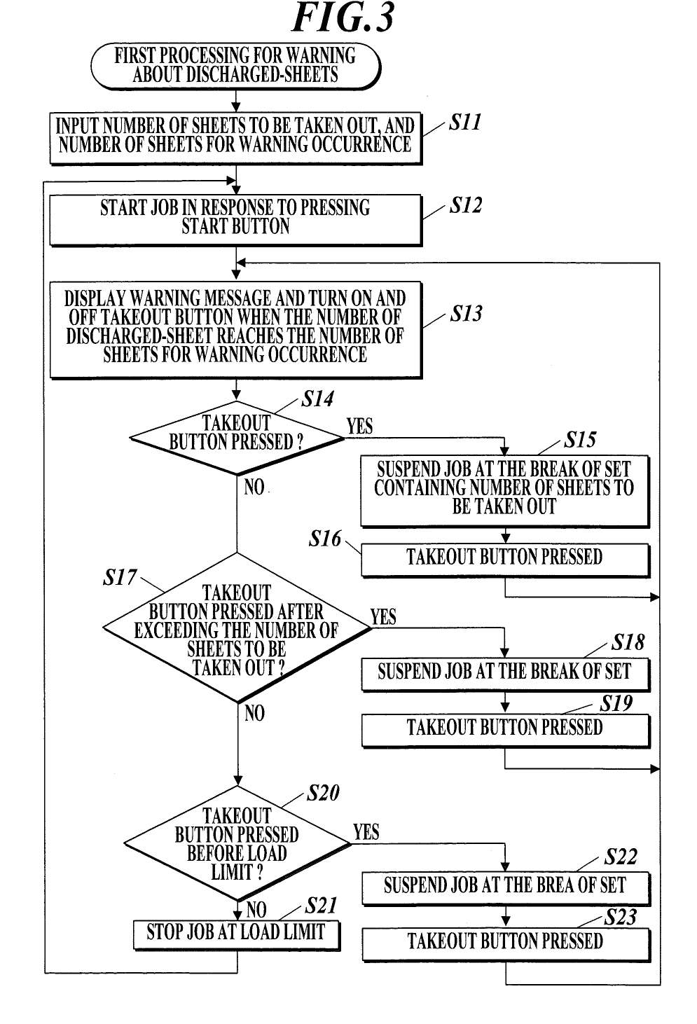

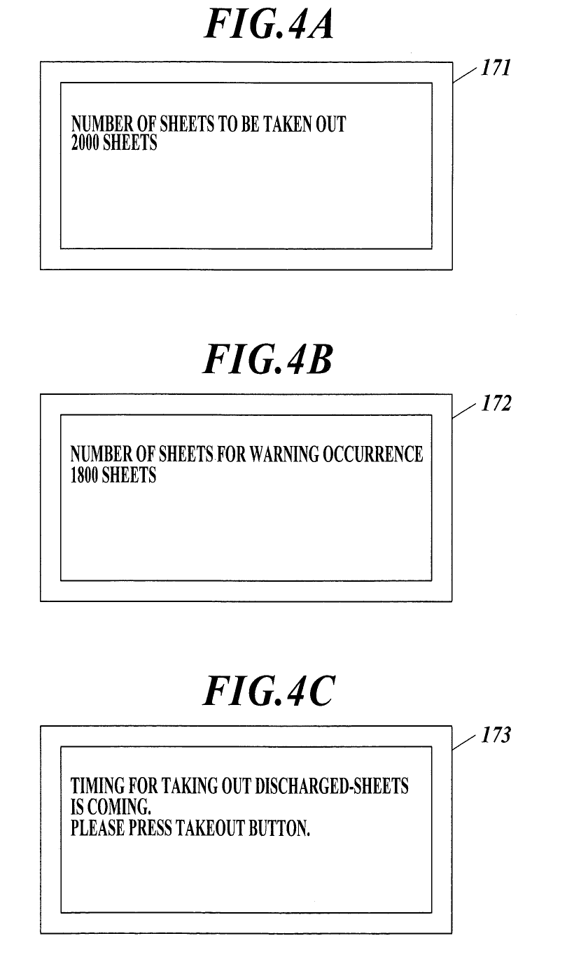

Next, the operation of the image forming apparatus 1 will be described with reference to FIGS. 3 to 4C. FIG. 3 shows a flow of the first processing for warning about discharged sheet. FIG. 4A shows an input screen 171 for inputting the number of sheet to be taken out. FIG. 4B shows an input screen 172 for inputting the number of sheet for warning occurrence. FIG. 4C shows a warning screen 173.

It is assumed that jobs such as the copying processing for forming the image by the image forming section 16 based on the image data of the original document read out by the image reading section 15, the processing for forming an image by the image forming section 16 based on the image data stored in the image memory 18, etc. are input and executed in the image forming apparatus 1. This image forming job may be a job of forming images of plural sets. Furthermore, it is assumed that the image forming job of plural sets is set to a shift mode in which printing is carried out while the print position is displaced every set or not set to the shift mode.

In the image forming apparatus 1, the controller 11 executes the first processing for warning about discharged sheet on the basis of the first sheet discharge warning program which is read out from ROM 13 and properly expanded into RAM 12 while the input of the image forming job described above is set as a trigger. In the first processing, it is assumed that when the image forming job is finished, the first processing for warning about discharged sheet is also finished, and it is also assumed that the same is satisfied in other sheet discharge processing.

As shown in FIG. 3, first, the input of the number of sheets to be taken out and the number of sheets for warning occurrence is accepted from the user through the operation and display section 17, and the number of sheet to be taken out and the number of sheet for warning occurrence are set (step S11). In step S11, an input screen 171 shown in FIG. 4A for inputting the number of sheet to be taken out is displayed on the operation and display section 17. The number of sheet to be taken out is input by touching a numerical button (not shown) or the like, for example. Likewise, the input screen 172 for inputting a number of sheets for warning occurrence shown in FIG. 4B is displayed on the operation and display section 17. The number of sheet for warning occurrence is input by touching a numerical button (not shown).

When the user presses the start button on the operation and display section 17 and an input of the pressing is accepted, the input job is started or the job under cease is resumed in step S21 described later (step S12). Subsequently, the number of discharged sheet discharged to the tray 28 is counted on a real-time basis.

When the number of discharged sheet being counted reaches the number of sheet for warning occurrence set in step S11, the warning message is displayed on the operation and display section 17, and (LED 26 of) the takeout button 25 is turned on and off (step S13). In step S13, the warning screen 173 containing the warning message shown in FIG. 4C is displayed.

The pressing and inputting of the takeout button 25 is ready to be accepted, and whether the takeout button 25 is pressed or not is identified (step 14). When the takeout button 25 is pressed (step S14: YES), the job (the image forming operation of the image forming section 16) is suspended while the set containing the number of sheet to be taken out of the job being executed is set as a break (step S15). When the pressing and inputting of the takeout button 25 is accepted (step S16), the job being suspended is resumed, and the processing shifts to step S13.

When the takeout button 25 is not pressed (step S14: NO), the pressing and inputting of the takeout button 25 is subsequently accepted, and after the number of discharged sheet under count exceeds the number of sheet to be taken out set in step S11, it is judged whether the takeout button 25 is pressed or not (step S17).

When the takeout button 25 is pressed after exceeding the number of sheet to be taken out (step S17; YES), the job is suspended at the end of the set under the present image formation of the job being executed is set as a break (step S18). When the pressing and inputting of the takeout button 25 is ready to be accepted and the takeout button 25 is pressed (step S19), the suspended job is resumed, and the processing shifts to step S13.

When the takeout button 25 is not pressed after exceeding the number of sheet to be taken out (step S17; NO), the pressing and inputting of the takeout button 25 is subsequently ready to be accepted, and it is judged whether the takeout button 25 is pressed or not before the number of discharged sheet under count exceeds the load limit (step S20). When the takeout button 25 is not pressed before the number of discharged sheet exceeds the load limit (step S20; NO), the job being executed is stopped at the stage that the number of discharged sheet under count reaches the load limit (step S21), and the processing shifts to step S12.

When the takeout button 25 is pressed before the number of discharged sheet exceeds the load limit number (step S20; YES), the job is suspended at the end of the set under the present image formation of the job being executed is set as a break (step S22). When the pressing and inputting of the takeout button 25 is accepted and the takeout button 25 is pressed (step S23), the suspended job is resumed, and the processing shifts to step S13.

According to this embodiment, after the start of the image forming job, the warning message is displayed on the operation and display section 17 in response to the fact that the number of discharged sheet under count reaches the number of sheet for warning occurrence input through the operation and display section 17, and LED 26 of the takeout button 25 is turned on and off. Therefore, the amount of discharged sheet on the tray 28 can be warned to the user in advance, and thus the loading failure of the discharged sheets on the tray 28 can be prevented.

After the warning about the amount of discharged sheet, the job is suspended by pressing the takeout button 25. Therefore, the user can easily take out the discharged sheets P from the tray 28 under the stop of the job.

Furthermore, the input of the number of sheet for warning occurrence is accepted through the operation and display section 17. Therefore, the number of sheet for warning occurrence can be easily input and set.

During the stop of the image forming job, the pressing and inputting of the takeout button 25 is ready to be accepted, and the suspended job is resumed in response to the press concerned. Therefore, the discharged sheets can be taken out from the tray 28 and the resume of the job can be instructed, whereby the suspended job can be manually resumed.

On the basis of the press of the takeout button 25 after the number of discharged sheet under count reaches the number of sheet for warning occurrence, the job (image formation) is suspended at the break of the set containing the number of sheet to be taken out, and on the basis of the press of the takeout button 25 after the number of discharged sheet under count reaches the number of sheet to be taken out, the job is suspended at the break of the set under image formation. Therefore, the discharged sheets can be easily taken out at the break of the set, the job can be stopped before the loading failure of the discharged sheets on the tray occurs, and the loading failure of the discharged sheets on the tray can be surely prevented. Particularly, in the shift mode, it can be prevented that the discharged sheets are collapsed due to the loading failure and thus the breaks of sets are indistinguishable from one another, and also the breaks of the sets can be recognized by the user, so that the user can easily take out the discharged sheets.

(Modification)

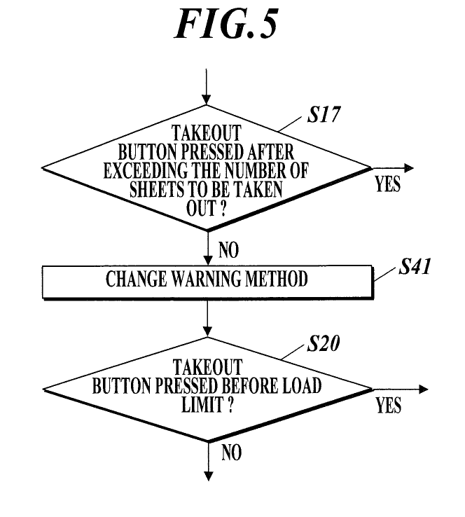

A modification of the first embodiment will be described with reference to FIG. 5. FIG. 5 shows the flow of the modification of the first processing for warning about discharged sheet.

The construction of the apparatus of the modification is the same as the first embodiment, and thus different parts will be mainly described. In this modification, the image forming apparatus 1 is used as in the case of the first embodiment.

As shown in FIG. 5, the operation of the image forming apparatus 1 of this modification is added with step S41 between the steps S17 and S20 in the first warning display processing shown in FIG. 3. When the takeout button 25 is not pressed (step S17; NO), the warning method in step S13 is changed (step S41), and the processing shifts to step S20. In step S41, for example, a message indicating that the number of sheet to be taken out is exceeded is displayed on the operation and display section 17 or the blinking speed of LED 26 of the takeout button 25 is increased.

According to this modification, when the number of discharged sheet under count reaches the number of sheet to be taken out, the blinking speed of LED 26 of the takeout button 25 is increased. Therefore, the warning of the discharge sheet amount can be reported to the user by revealing that the discharge sheet number under count exceeds the number of sheet to be taken out.

### Second Embodiment

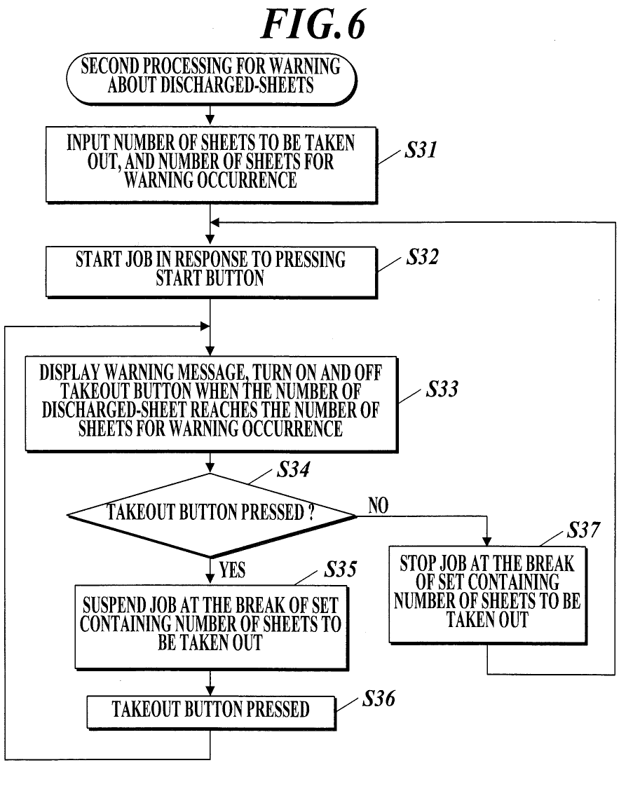

A second embodiment according to the present invention will be described with reference to FIG. 6. FIG. 6 shows the flow of second processing for warning about discharged sheets.

The construction of the apparatus of this embodiment is the same as the first embodiment, and different parts will be mainly described. In this embodiment, the image forming apparatus 1 is used as in the case of the first embodiment. In place of the first sheet discharge warning program, a second sheet discharge warning program is stored in ROM 13 of the main body section 10.

The operation of the image forming apparatus 1 according to this embodiment will be described. In the image forming apparatus 1, the second processing for warning about discharged sheet is executed by the controller 11 on the basis of the second sheet discharge warning program which is read out from ROM and properly developed into RAM 12 with the input of the image forming job set as a trigger.

As shown in FIG. 6, the steps S31 to S34 are the same as the steps S11 to S14 of the first processing for warning about discharged sheet. When the takeout button 25 is pressed after exceeding the number of sheet for warning occurrence (step S34; YES), the image forming job is suspended while the set containing the number of sheet to be taken out of the job being executed is set as a break (step S35). When the pressing and inputting of the takeout button 25 is ready to be accepted and the takeout button 25 is pressed (step S36), the suspended job is resumed, and then the processing shifts to step S33.

When the takeout button 25 is not pressed after exceeding the number of sheet for warning occurrence (step S34; NO), the job being executed is stopped while the set containing the number of sheet to be taken out of the job being executed is set as a break (step S37), and then the processing shifts to step S32.

According to this embodiment, on the basis of the press of the takeout button 25 after the number of discharged sheet under count reaches the number of sheet for warning occurrence, the image forming job is stopped at the break of the set containing the number of sheet to be taken out. Therefore, the image forming job can be stopped at a favorable break, the job can be stopped before the loading failure of the discharged sheets on the tray occurs, and the loading failure of the discharged sheets can be surely prevented.

### Third Embodiment

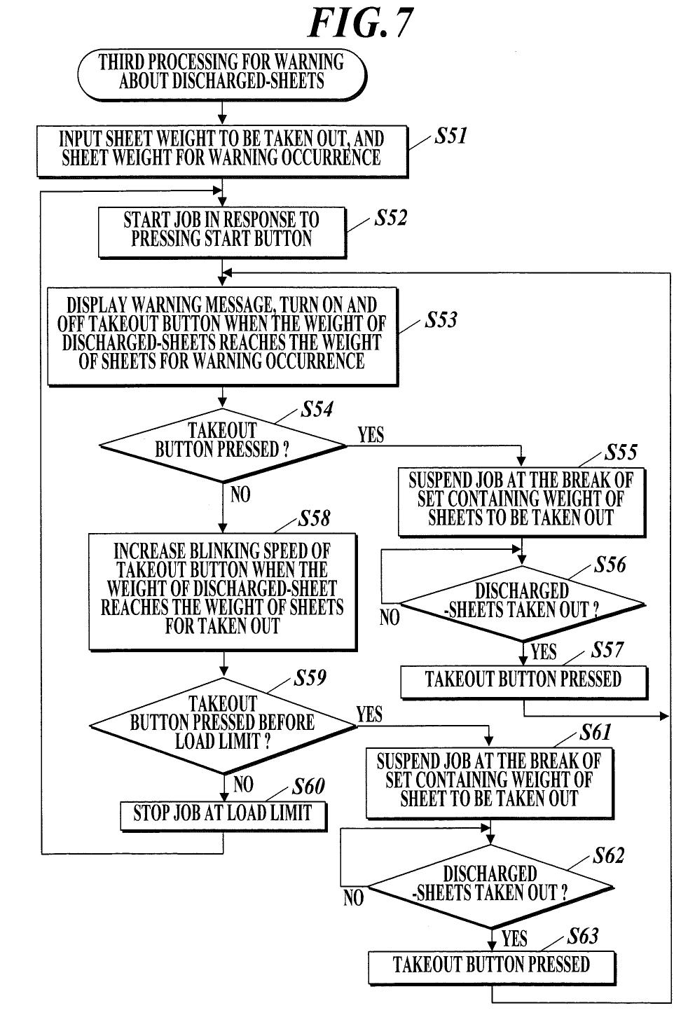

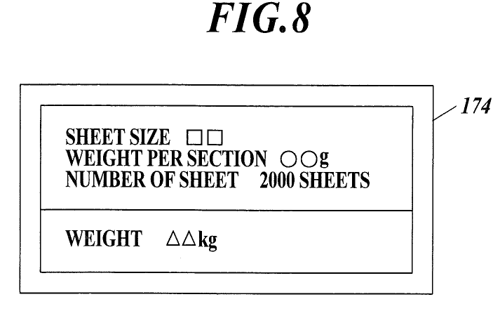

A third embodiment according to the present invention will be described with reference to FIGS. 7 and 8. FIG. 7 shows the flow of the third processing for warning about discharged sheet. FIG. 8 shows an input screen 174 for inputting a weight of sheets to be taken out.

The construction of the apparatus of this embodiment is the same as the first embodiment, and different parts will be mainly described. In this embodiment, the image forming apparatus 1 is used as in the case of the first embodiment. In place of the first sheet discharge warning program, a third sheet discharge warning program is stored in ROM 13 of the main body section 10.

The operation of the image forming apparatus 1 according to this embodiment will be described. In the image forming apparatus 1, the third processing for warning about discharged sheet is executed by the controller 11 on the basis of the third sheet discharge warning program which is read out from ROM 13 and properly expanded into RAM 12 with the input of the image forming job as a trigger.

As shown in FIG. 7, an input of sheet weight to be taken out and sheet weight for warning occurrence from the user through the operation and display section 17 is accepted and set (step S51). The sheet weight to be taken out, the sheet weight for warning occurrence and the load limit weight represent the number of sheet to be taken out, the number of sheet for warning occurrence and the number of sheet of load limit respectively in terms of weight. In step S51, for example, an input screen 174 for inputting a weight of sheets to be taken out shown in FIG. 8 is displayed on the operation and display section 17, and the sheet size, the weight per section and the number of sheets which correspond to the weight of sheet to be taken out are input by touching a selection button, numeric buttons, and the weight of sheets to be taken out corresponding to the input sheet size, the weight per section and the number of sheet is calculated and displayed, whereby the weight of sheets to be taken out is input and settled. The weight of sheets to be taken out=weight per section X sheet size (surface area) X number of sheets. For example, when the sheet size=A4 size (surface area=0.06237 [m²]), the weight per section=80 [g/m²] and the number of sheets=3000 [sheets], the weight of sheets to be taken out÷15 [kg] according to the above calculation equation. The same is applied to the input of the weight of sheets for warning occurrence.

When the pressing and inputting of the start button from the user through the operation and display section 17 is accepted, the input job is started or the job stopped in step S60 described later is resumed (step S52). Subsequently, the weight of the discharged sheets discharged onto the tray 28 is measured on a real-time basis by the weight measuring section 29.

When the weight of discharged sheet under measurement reaches the weight of sheets for warning occurrence set in step S51, the warning message is displayed on the operation and display section 17, and (LED 26 of) the takeout button 25 is turned on and off (step S53). In step S53, for example, a warning screen 173 containing a warning message shown in FIG. 4C is displayed.

The pressing and inputting of the takeout button 25 is ready to be accepted, and it is judged whether the takeout button 25 is pressed or not (step S54). When the takeout button 25 is pressed (step S54; YES), the image forming job is suspended while the set containing the weight of sheet to be taken out the job being executed is set as a break (step S55). On the basis of the value of the weight of discharged sheets being measured by the weight measuring section 29, it is judged whether the discharged sheets containing the weight of sheets to be taken out are taken out from the tray 28 (step S56). In step S56, the takeout of the discharged sheets concerned is judged when the weight of discharged sheets under measurement is equal to zero or the like which indicates that the discharged sheets have been taken out, for example.

When the discharged sheets have not yet been taken out (step S56; NO), the processing shifts to step S56. When the discharged sheets have been taken out (step S56; YES), and also when the pressing and inputting of the takeout button 25 is accepted and the takeout button 25 is pressed (step S57), the suspended job is resumed, and the processing shifts to step S53.

In the case where the takeout button 25 is not pressed after exceeding the weight for warning occurrence (step S54; NO), the blinking speed of LED 26 of the takeout button 25 is controlled to increase when the weight of discharged sheets under measurement reaches the weight of sheets to be taken out set in step S51 (step S58). Subsequently, the pressing and inputting of the takeout button 25 is ready to be accepted and it is judged whether the takeout button 25 is pressed before the weight of discharged sheets under measurement exceeds the load limit weight (step S59). When the takeout button 25 is not pressed before the weight of discharged sheets under measurement exceeds the load limit weight (step S59; NO), the job being executed is stopped at the stage that the weight of discharged sheets under measurement reaches the load limit weight (step S60), and the processing shifts to step S52.

When the takeout button 25 is pressed before the weight of discharged sheets under measurement exceeds the load limit weight (step S59; YES), the job is suspended while the set under the present image formation of the job being executed is set as a break (step S61). On the basis of the measurement value of the weight of discharged sheets measured by the weight measuring section 29, it is judged whether the discharged sheets containing the weight of sheets to be taken out are taken out from the tray 28 (step S62).

When the discharged sheets are not taken out (step S62; NO), the processing waits until the discharged sheets are taken out. When the discharged sheets are taken out (step S62; YES), the pressing and inputting of the takeout button 25 is accepted, and when the takeout button 25 is pressed (step S63), the suspended job is resumed and the processing shifts to step S53.

According to this embodiment, a weight of the discharged sheet measured by the weight measuring section 29 and the weight of sheets to be taken out can be compared with each other, and the measured weight of discharged sheet and the weight of sheets for warning occurrence can be compared with each other.

Furthermore, during the stop of the job, the discharged sheet is measured by the weight measuring section 29, and when the discharged sheet weight reaches the weight indicating that the takeout of the discharged sheets is completed, the pressing and inputting of the takeout button 25 is accepted and the suspended job is resumed in response to the press concerned. Therefore, the discharged sheets can be taken out from the tray 28 and the resume of the job can be instructed during the stop of the job, and the suspended job can be resumed automatically and manually. Particularly, it can be prevented that the takeout button 25 is pressed to resume the job without taking out the discharged sheets from the tray 28 and the load failure occurs.

The description on the above embodiments and the modification is applied to examples of the preferable image forming apparatus according to the present invention, and it is not limited to the examples.

For example, in the above embodiments and the modification, the job is suspended (the temporary stop of the job with the set containing the number of sheet to be taken out as a break) when the discharge sheet number reaches the number of sheet to be taken out simultaneously with the warning of the discharge sheet amount by the operation and display section 17 and the takeout button 25 when the discharged sheet number under count reaches the number of sheet for warning occurrence. However, the present invention is not limited to this mode. For example, at least one of the warning of the discharge sheet amount and the temporary stop of the job may be executed on the basis of the comparison result between the number of discharged sheet under count and the number of sheet for warning occurrence. According to this construction, on the basis of the comparison result of the obtained discharged amount of sheet and the set amount of discharged sheet, at least one of the warning before the load failure of the discharged sheets on the tray and the stop of the job before the load failure can be executed, and the load failure of the discharged sheets on the tray can be prevented.

Furthermore, two or more of the above embodiments and the modification may be properly combined with each other. For example, the first embodiment may be modified so that the takeout sheet weight and the warning occurrence sheet weight are set, the discharge sheet weight is measured by the weight measuring section 29 in place of the discharge sheet number, and the measured discharge sheet weight, the takeout sheet weight and the warning occurrence sheet weight are compared with one another.

Furthermore, in the above embodiments and the modification, the number of sheet to be taken out (takeout sheet weight) and the number of sheet for warning occurrence (weight of sheet for warning occurrence) are input and set through the operation and display section 17, however, the present invention is not limited to this mode. For example, the number of sheet to be taken out (weight of sheets to be taken out) may be input and set through the operation and display section 17 and the number of sheet for warning occurrence (weight of sheet for warning occurrence) may be calculated and set from the number of sheet to be taken out (weight of sheet to be taken out) according to a predetermined method. For example, after the number of sheet to be taken out (weight of sheet to be taken out) is input, the number of sheet for warning occurrence (weight of sheet for warning occurrence) may be automatically calculated to X % (X: constant, and it is equal to 90, for example) of the number of sheet to be taken out (weight of sheet to be taken out). Furthermore, the number of sheet for warning occurrence (weight of sheet for warning occurrence) may be set to be equal to the number of sheet to be taken out (takeout sheet weight). According to this construction, the number of sheet for warning occurrence (weight of sheet for warning occurrence) corresponding to the number of sheet to be taken out (weight of sheet to be taken out) can be easily calculated and set.

Still furthermore, according to the third embodiment, when the discharged sheets are taken out from the tray 28 after the image forming job is stopped in step S55 or S61, the job is resumed in response to the press of the takeout button 25. However, the present invention is not limited to this mode. For example, the third embodiment may be modified so that the job is automatically resumed when the discharge sheets are taken out from the tray 28 after the job is stopped. Furthermore, the third embodiment may be modified so that when a fixed time elapses after stop of the job, it is regarded that the user takes out the discharge sheets, and the job is automatically resumed. Still furthermore, the third embodiment may be modified so that the job is automatically resumed in response to release of a sheet detecting sensor (not shown) provided to the tray 28 or the like.

In the above embodiments and the modification, when the number of discharged sheet under count exceeds the number of sheet for warning occurrence (weight of sheet for warning occurrence), (LED 26 of) the takeout button 25 is turned on and off, and the warning screen is displayed on the operation and display section 17, whereby a warning is reported to the user. However, the present invention is not limited to this mode, for example, the takeout button 25 may be turned on. The warning may be reported by any one of the blinking (turn-on) of the takeout button 25 and the display of the warning screen. Furthermore, as the manner of reporting the warning may be adopted a manner of performing another sheet discharge from that of the image formation of the job (for example, a black-painted image is formed on a sheet and the sheet is discharged, a black-printed sheet or the like which is set on the sheet supply tray in advance is discharged without image formation), a manner of warning by outputting sounds, a manner of transmitting warning information to external equipment (PC or the like) connected to the image forming apparatus 1 and displaying the warning information on the external equipment or the like, or a combination of these manners.

Still furthermore, in the third embodiment and the modification, when the number of discharged sheet under count reaches the number of sheet to be taken out (weight of sheet for warning occurrence), the blinking speed of (LED 26 of) the takeout button 25 is increased. However, the present invention is not limited to this method. For example, there may be adopted a method of switching the blinking and the lighting of (LED 26 of) the takeout button 25 to each other or changing lighting brightness or lighting color when the discharge sheet number under count reaches the number of sheet to be taken out (weight of sheet for warning occurrence), or a method of changing the display screen (message or the like) of the operation and display section 17 when the number of discharged sheet under count reaches the number of sheet to be taken out (weight of sheet for warning occurrence), a method of outputting sounds, a method of transmitting warning information to external equipment and displaying the warning information on the external equipment or the like, or a combination of these methods.

Still furthermore, in the respective embodiments and the modification, the image formation is suspended at the break of the set containing the number of sheet to be taken out in steps S15, S35, S55, etc., however, the present invention is not limited to this mode. For example, the image formation may be suspended at the break of a set, which does not exceed the number of sheet to be taken out.

In the second embodiment, the job is stopped at the break of the set containing the number of sheet to be taken out when the takeout button 25 is pressed, however, the present invention is not limited to this mode. For example, the job may be stopped immediately when the takeout button 25 is pressed.

Furthermore, in the above embodiments and the modification, in the image forming apparatus 1, the takeout button (LED 26), the tray 28, the weight measuring section 29, etc. are provided to the sheet finisher 20. However, the present invention is not limited to this mode, but may be applied to an image forming apparatus in which the takeout button 25 (LED 26), the tray 28, the weight measuring section 29, etc. are provided to the main body side (the sheet finisher is not provided).

Still Furthermore, The detailed constructions and detailed operations of the respective parts constituting the image forming apparatus 1 according to the above embodiments and the modification may be properly modified without departing from the subject matter of the present invention.

### FIGURES

FIG. 1
10 . . . MAIN BODY SECTION
20 . . . SHEET FINISHER

FIG. 2
11 . . . CONTROLLER
14 . . . SHEET FINISHER I/F
15 . . . IMAGE READING SECTION
16 . . . IMAGE FORMING SECTION
17 . . . OPERATION AND DISPLAY SECTION
18 . . . IMAGE MEMORY
24 . . . MAIN BODY SECTION I/F
25 . . . TAKEOUT BUTTON
27 . . . TRAY DRIVING SECTION
29 . . . WEIGHT MEASURING SECTION
251 . . . INPUT SECTION
261 . . . OUTPUT SECTION

FIG. 3
FIRST PROCESSING FOR WARNING ABOUT DISCHARGED-SHEET
S11 . . . INPUT NUMBER OF SHEET TO BE TAKEN OUT, AND NUMBER OF SHEET FOR WARNING OCCURRENCE
S12 . . . START JOB IN RESPONSE TO PRESSING START BUTTON
S13 . . . DISPLAY WARNING MESSAGE AND TURN ON AND OFF TAKEOUT BUTTON WHEN THE NUMBER OF DISCHARGED-SHEET REACHES THE NUMBER OF SHEET FOR WARNING OCCURRENCE
S14 . . . TAKEOUT BUTTON PRESSED ?
S15 . . . SUSPEND JOB AT THE BREAK OF SET CONTAINING NUMBER OF SHEET TO BE TAKEN OUT
S16 . . . TAKEOUT BUTTON PRESSED
S17 . . . TAKEOUT BUTTON PRESSED OVER A NUMBER OF SHEET TO BE TAKEN OUT ?
S18 . . . SUSPEND JOB AT THE BREAK OF SET
S19 . . . TAKEOUT BUTTON PRESSED
S20 . . . TAKEOUT BUTTON PRESSED BEFORE LOAD LIMIT ?
S21 . . . STOP JOB AT LOAD LIMIT
S22 . . . SUSPEND JOB AT THE BREA OF SET
S23 . . . TAKEOUT BUTTON PRESSED

FIG. 4A
NUMBER OF SHEET TO BE TAKEN OUT, 2000 SHEETS

FIG. 4B
NUMBER OF SHEET FOR WARNING OCCURRENCE, 1800 SHEETS

FIG. 4C
TIMING FOR TAKING OUT DISCHARGED-SHEET IS COMING. PLEASE PRESS TAKEOUT BUTTON.

FIG. 5
S17 . . . TAKEOUT BUTTON PRESSED OVER A NUMBER OF SHEET TO BE TAKEN OUT ?
S41 . . . CHANGE WARNING METHOD
S20 . . . TAKEOUT BUTTON PRESSED BEFORE LOAD LIMIT ?

FIG. 6
SECOND PROCESSING FOR WARNING ABOUT DISCHARGED-SHEET
S31 . . . INPUT NUMBER OF SHEET TO BE TAKEN OUT, AND NUMBER OF SHEET FOR WARNING OCCURRENCE
S32 . . . START JOB IN RESPONSE TO PRESSING START BUTTON
S33 . . . DISPLAY WARNING MESSAGE, TURN ON AND OFF TAKEOUT BUTTON WHEN THE NUMBER OF DISCHARGED-SHEET REACHES THE NUMBER OF SHEET FOR WARNING OCCURRENCE
S34 . . . TAKEOUT BUTTON PRESSED ?
S35 . . . SUSPEND JOB AT THE BREAK OF SET CONTAINING NUMBER OF SHEET TO BE TAKEN OUT
S36 . . . TAKEOUT BUTTON PRESSED
S37 . . . STOP JOB AT THE BREAK OF SET CONTAINING NUMBER OF SHEET TO BE TAKEN OUT

FIG. 7
THIRD PROCESSING FOR WARNING ABOUT DISCHARGED-SHEET
S51 . . . INPUT SHEET WEIGHT TO BE TAKEN OUT, AND SHEET WEIGHT FOR WARNING OCCURRENCE
S52 . . . START JOB IN RESPONSE TO PRESSING START BUTTON
S53 . . . DISPLAY WARNING MESSAGE, TURN ON AND OFF TAKEOUT BUTTON WHEN THE WEIGHT OF DISCHARGED-SHEET REACHES THE WEIGHT OF SHEET FOR WARNING OCCURRENCE
S54 . . . TAKEOUT BUTTON PRESSED ?
S55 . . . SUSPEND JOB AT THE BREAK OF SET CONTAINING WEIGHT OF SHEET TO BE TAKEN OUT
S56 . . . DISCHARGED-SHEET TAKEN OUT ?
S57 . . . TAKEOUT BUTTON PRESSED
S58 . . . INCREASE BLINKING SPEED OF TAKEOUT BUTTON WHEN THE WEIGHT OF DISCHARGED-SHEET REACHES THE WEIGHT OF SHEET FOR TAKEN OUT
S59 . . . TAKEOUT BUTTON PRESSED BEFORE LOAD LIMIT ?
S60 . . . STOP JOB AT LOAD LIMIT
S61 . . . SUSPEND JOB AT THE BREAK OF SET CONTAINING WEIGHT OF SHEET TO BE TAKEN OUT
S62 . . . DISCHARGED-SHEET TAKEN OUT ?
S63 . . . TAKEOUT BUTTON PRESSED

FIG. 8
SHEET SIZE □□
WEIGHT PER UNIT OO g
NUMBER OF SHEET 2000 SHEETS
WEIGHT ΔΔ kg

What is claimed is:

1. An image forming apparatus comprising:
an image forming section for forming an image on a sheet;
a tray on which an image-formed sheet is discharged as a discharged-sheet; and
a controller for setting an amount of sheet to be discharged, the amount being smaller than a load limit of discharged-sheet on the tray, obtaining an amount of the sheet on the tray, comparing the obtained amount of the sheet with the set amount of the sheet, and executing at least one of warning about the amount of the discharged-sheet and stopping an image forming job for driving the image forming section on the basis of the comparison result.

2. An image forming apparatus comprising:
an image forming section for forming an image on a sheet;
a tray on which an image-formed sheet is discharged as a discharged-sheet;
an informing section for informing a warning; and
a controller for setting a first amount of the discharged-sheet at which a warning about the amount of the discharged-sheet should be performed before a load limit of the tray, obtaining an amount of the discharged-sheet on the tray, comparing the obtained amount of the discharged-sheet with the first amount of the discharged-sheet, and making the informing section inform the warning about the amount of the discharged-sheet when the obtained amount of the discharged-sheet reaches the first amount of the discharged-sheet.

3. The image forming apparatus according to claim 2, further comprising a first operating section for accepting an input about a second amount of the discharged-sheet on the tray to be taken out before the load limit, wherein the controller sets the second amount of the discharged-sheet input from the first operating section, starts an image forming job to make the image forming section form an image, obtains an amount of the discharged-sheet on the tray, compares the obtained amount of the discharged-sheet with the second amount of the discharged-sheet, and stops the job when the obtained amount of the discharged-sheet exceeds the second amount of the discharged-sheet.

4. The image forming apparatus according to claim 2, further comprising a second operating section for accepting an input about the first amount of the discharged-sheet, wherein the controller sets the first amount of the discharged-sheet input from the second operating section.

5. The image forming apparatus according to claim 3, wherein the controller calculates and sets the first amount of the discharged-sheet corresponding to the second amount of the discharged-sheet input from the first operating section.

6. The image forming apparatus according to claim 2, further comprising a weight measuring section for measuring the weight of discharged-sheet on the tray as an amount of the discharged-sheet, wherein the controller compares the amount of the discharged-sheet obtained through the measurement by the weight measuring section with the set first amount of the discharged-sheet.

7. The image forming apparatus according to claim 3, further comprising a discharged-sheet detecting section for detecting discharged-sheet on the tray, wherein during the stop of the job, the controller resumes the suspended job when no discharged-sheet on the tray is detected by the discharged-sheet detecting section.

8. The image forming apparatus according to claim 3, wherein the controller stops the job at the break of a set including the set second amount of the discharged-sheet or at the break of a set which does not exceed the second amount of the discharged-sheet.

9. The image forming apparatus according to claim 3, wherein the controller changes an informing method of the informing section when the obtained amount of the discharged-sheet reaches the second amount of the discharged-sheet.

10. The image forming apparatus according to claim 2, further comprising a third operating section for accepting an input of an instruction for stopping the job, wherein the controller stops the job when an instruction of stopping the job is input from the third operating section after a warning of the amount of the discharged-sheet is informed.

11. The image forming apparatus according to claim 3, further comprising a fourth operating section for accepting an input of an instruction for resuming the job, wherein during stop of the job, the controller resumes the suspended job when an instruction of resuming the job is input from the fourth operating section.
